(19) United States
(12) Patent Application Publication
(10) Pub. No.: US 2025/0135335 A1
(43) Pub. Date: May 1, 2025

(54) OFFLOADING STREAM PROCESSING TASKS TO PARALLEL PROCESSING UNITS FOR CONTENT STREAMING SYSTEMS AND APPLICATIONS

(71) Applicant: NVIDIA Corporation, Santa Clara, CA (US)

(72) Inventors: Amit Parikh, Santa Clara, CA (US); Ganapathy Raman Kasi, Fremont, CA (US); Timothy Andrew Prinz, Seattle, WA (US)

(21) Appl. No.: 18/496,147

(22) Filed: Oct. 27, 2023

(51) Int. Cl. A63F 13/355

(52) U.S. Cl. CPC A63F 13/355

(57) ABSTRACT

In various examples, processing content data using parallel processing units for content streaming systems and applications is described herein. Systems and methods are disclosed that determine when to offload at least a portion of the processing that is typically performed by a central processing unit (CPU) to a parallel processing unit (PPU). For example, and for an application, a profile may be generated that includes information associated the application, such as one or more processing metrics associated with the application and/or which processes, if any, should be offloaded. In some examples, the profile may be generated using processing statistics associated with one or more previous streaming sessions associated with the application. The systems and methods may then use the profile and/or other data to determine whether to offload one or more processes from the CPU to the PPU (and/or, in some examples, from the PPU to the CPU).

### BACKGROUND

Conventional streaming systems that process content for various applications, such as online gaming applications, video streaming applications, and/or the like, often perform processing over multiple stages that are sequentially arranged as a processing pipeline. For example, when an online gaming application is being streamed to a connected client device, a conventional system may use a graphics processing unit (GPU) to generate and then encode a video stream associated with the online gaming application. Such a conventional system may then process the video data and/or associated audio data using a central processing unit (CPU). For example, the CPU may process the video data and/or the audio data using a processing stack that performs packetization, forward error correction (FEC), and/or encryption. After processing the video stream and/or the audio stream using the CPU, the conventional system may then send the processed video data and/or the processed audio data to the client device.

However, problems may occur when generating encoded video streams using a GPU that are then further processed using a CPU. For instance, in some scenarios, a GPU may be encoding multiple video streams associated with different application sessions at a single instance, where each of the encoded video streams then needs to be processed according to the remainder of the a video processing stack—executed at a CPU—before being sent to the client devices. However, processing the multiple encoded video streams using the CPU may require a large amount of CPU resources and/or may increase the latency associated with the CPU processing. Additionally, in some scenarios, a configuration associated with a specific game and its corresponding video stream processing may dedicate a given number of processing cores of a CPU to the specific game and corresponding the video stream, such as two cores or three cores. However, based on an application associated with the video stream, the CPU may be unable to process the video stream using the number of cores without increasing the processing latency and/or reducing the frame rate of the video stream. As such, and in such scenarios, the conventional systems may need to increase the number of cores dedicated to the video stream.

### SUMMARY

Embodiments of the present disclosure relate to processing content data using parallel processing units (e.g., graphics processing units, hardware accelerators, etc.) for content streaming systems and applications. Systems and methods are disclosed for determining and coordinating the offloading of at least a portion of the processing that is typically performed by a central processing unit (CPU) to a parallel processing unit (PPU). For example, and for an application, a profile may be generated that includes information associated with the application, such as one or more processing metrics associated with the application and/or which processes, if any, should be offloaded. In some examples, the profile may be generated using processing statistics associated with one or more previous streaming sessions associated with the application. The systems and methods may then use the profile and/or other data to determine whether to offload one or more processes from the CPU to the PPU (and/or, in some examples, from the PPU to the CPU).

In contrast to conventional systems, such as those described herein, the current systems, in some embodiments, are able to use a PPU (e.g., a graphics processing unit, a data processing unit, any other hardware accelerator) to perform at least a portion of the processing that is conventionally performed by the processing stack of the CPU. For instance, and as described herein, the processing stack of the CPU of conventional systems may process the content stream that includes data transport processes, such as (for example and without limitation) packetization, FEC, and/or encryption. However, by determining to move at least a portion of the processing of the content stream to the PPU, the current systems are able to reduce the latency associated with processing the content stream and/or reduce the amount of CPU resources that is needed for processing the content stream. In some examples, such improvements are even more prevalent in specific scenarios, such as when a GPU is being used generate and/or encode multiple content streams in parallel and/or a CPU is executing multiple threads on different cores.

### BRIEF DESCRIPTION OF THE DRAWINGS

The present systems and methods for processing content data using parallel processing units for content streaming systems and applications are described in detail below with reference to the attached drawing figures, wherein:

FIG. 1A illustrates an example data flow diagram for a process of determining whether to offload at least a portion of processing to one or more parallel processing units, in accordance with some embodiments of the present disclosure;

FIG. 1B illustrates an example data flow diagram for a process of processing content data using one or more parallel processing units, in accordance with some embodiments of the present disclosure;

FIG. 2 illustrates an example of a profile that may be used to allocate processes between one or more parallel processing units and one or more central processing units, in accordance with some embodiments of the present disclosure;

FIGS. 3A-3C illustrate examples of performance metrics associated with an application, in accordance with some embodiments of the present disclosure;

FIG. 4 illustrates an example of one or more parallel processing units processing content data using packetization, in accordance with some embodiments of the present disclosure;

FIG. 5 illustrates an example of one or more parallel processing units processing content data using forward error correction, in accordance with some embodiments of the present disclosure;

FIG. 6 illustrates an example of one or more parallel processing units encoding content data, in accordance with some embodiments of the present disclosure;

FIG. 7 illustrates an example of one or more parallel processing units encrypting content data, in accordance with some embodiments of the present disclosure;

FIG. 8 illustrates an example of one or more central processing units processing content data using packetization, in accordance with some embodiments of the present disclosure;

FIG. 9 illustrates an example of one or more central processing units processing content data using forward error correction, in accordance with some embodiments of the present disclosure;

FIG. 10 illustrates an example of one or more central processing units encrypting content data, in accordance with some embodiments of the present disclosure;

FIG. 11 is a flow diagram showing a method for determining when to offload at least a portion of processing to one or more parallel processing units, in accordance with some embodiments of the present disclosure;

FIG. 12 is a flow diagram showing a method for processing content data using one or more parallel processing units, in accordance with some embodiments of the present disclosure;

FIG. 13 is a block diagram of an example content streaming system suitable for use in implementing some embodiments of the present disclosure;

FIG. 14 is a block diagram of an example computing device suitable for use in implementing some embodiments of the present disclosure; and

FIG. 15 is a block diagram of an example data center suitable for use in implementing some embodiments of the present disclosure.

### DETAILED DESCRIPTION

Systems and methods are disclosed related to processing content data using parallel processing units for content streaming systems and applications. Disclosed embodiments may be comprised in a variety of different systems such as streaming systems (e.g., game streaming systems), automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for processing data, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

For instance, a system(s) may be providing one or more content streams associated with one or more applications to one or more client devices. As described herein, a content stream may include a game stream associated with a gaming application, a movie stream associated with a video streaming application, a content stream associated with a (collaborative) content creation application, a content stream associated with a communications application, and/or other type of data stream associated with any other type of application. For example, and for a session associated with a gaming application, the system(s) may receive data from a client device, such as input data representing one or more inputs received by the client device during the session. The system(s) may then process the input data and, based at least on the processing, generate content data (e.g., video data, audio data, etc.) associated with the session. As described herein, the system(s) may use one or more parallel processing units (PPU(s)) (e.g., one or more graphics processing units, one or more data processing units, one or more hardware accelerators, etc.) and/or one or more central processing units (CPU(s)) to generate the content data. The system(s) may then send the content data to the client device so that the client device is able to display or otherwise present content represented by the content data to a user. This process may then continue to repeat during the session between the system(s) and the client device.

As described herein, the system(s) may use one or more techniques to determine whether to offload at least a portion of the (e.g., data transport) processing that is typically performed by the CPU(s) to the PPU(s) and/or whether to offload at least a portion of the processing that is typically performed by the PPU(s) to the CPU(s). For example, and for an application, the system(s) may receive, obtain, generate, and/or retrieve data indicating one or more first (e.g., data transport) processes that are to be performed by the PPU(s), one or more second processes that are to be performed by the CPU(s), one or more processing metrics associated with the application, and/or any other information associated with the application. In some examples, the data may represent a profile that is generated for the application and includes the information.

As described herein, a process (e.g., a data transport process) may include, but is not limited to, packetization, forward error correction (FEC), encoding, encryption, pace processing, and/or any other type of process that may be performed on content data (e.g., video data, audio data, image data, location data, etc.) to prepare for transport of the content data to another device. Additionally, in some examples, the one or more processing metrics may be associated with one or more measured performances of the PPU(s) and/or the CPU(s) based on one or more processing configurations. For a first example, a processing metric associated with the CPU(s) may include, but is not limited to, a first number of errors (e.g., stutters per minute, frame drops, etc.) over a period of time when the CPU(s) includes a first configuration (e.g., 2 cores), a second number of errors over the period of time when the CPU(s) includes a second configuration (e.g., 3 cores), a third number of errors over the period of time when the CPU(s) includes a third configuration (e.g., 2 cores, without performing a specific process like encryption), a fourth number of errors over the period of time when the CPU(s) includes a fourth configuration (e.g., 2 cores, without performing multiple processes like encryption and FEC), and/or so forth. For a second example, a processing metric associated with the PPU(s) may include, but is not limited to, a first number of errors (e.g., stutters per minute, frame drops, etc.) over a period of time when the PPU(s) includes a first configuration (e.g., 2 cores), a second number of errors over the period of time when the PPU(s) includes a second configuration (e.g., 3 cores), a third number of errors over the period of time when the PPU(s) includes a third configuration (e.g., 2 cores, without performing a specific process like encryption), a fourth number of errors over the period of time when the PPU(s) includes a fourth configuration (e.g., 2 cores, without performing multiple processes like encryption and FEC), and/or so forth.

In some examples, and as described herein, the system(s) (and/or one or more other systems) may generate the (e.g., telemetry) data using one or more performance statistics associated with one or more previous sessions associated with the application. As described herein, a performance statistic may include, but is not limited to, an amount (e.g., percentage, number of cores, etc.) of a PPU utilized, an amount (e.g., percentage, number of cores, etc.) of a CPU utilized, an amount (e.g., percentage) of a PPU utilized by a specific process, an amount (e.g., percentage) of a CPU utilized by a specific process, a frame rate, a frame drop rate, a network bandwidth, a latency rate, a minimum resolution, a maximum resolution, and/or any other processing statistic that may be measured for a session of an application.

In some examples, and for a session, such as when the (e.g., telemetry) data indicates the first process(es) that are to be performed by the PPU(s) and the second process(es) that are to be performed by the CPU(s), the system(s) may directly use those indications to offload the processing. For example, if the data indicates that the PPU(s) is to perform FEC and encryption while the CPU(s) is to perform packetization, then the system(s) may determine that the PPU(s) will process content data using FEC and encryption during the session while the CPU(s) processes the content data using packetization during the session. In some examples, such as when the data indicates the processing metric(s) without indicating the allocation of the processes, the system(s) may use the processing metric(s) to offload the processing. For instance, the system(s) may offload the processing such that the session satisfies one or more performance thresholds.

For example, the system(s) may determine that a performance threshold associated with a session is 20 stutters per minute. Additionally, the (e.g., telemetry) data associated with the application may indicate that there is an average of 40 stutters per minute when the CPU(s) performs all or substantially all of the processing, 18 stutters per minute when the CPU(s) does not perform encryption, and 16 stutters per minute when the CPU(s) does not perform encryption and FEC. As such, the system(s) may determine to offload at least the encryption to the PPU(s) such that the stutters per minute satisfy (e.g., are less than or equal to) the performance threshold of 20 stutters per minute. In some examples, the system(s) may perform similar processing for other types of performance thresholds, such as a frame rate threshold, a network bandwidth threshold, a latency threshold, a minimum resolution threshold, a maximum resolution threshold, a packet drop threshold, and/or so forth.

In some examples, the system(s) may use additional and/or alternative telemetry characteristics when determining whether to offload processing. For example, the system(s) may use a number of sessions currently being executed by the PPU(s), a number of sessions currently being executed by the CPU(s), a number cores of the PPU(s) that the application requires, a number of cores of the CPU(s) that the application requires, one or more performance capabilities (e.g., a number of cores, a number of threads, a processing speed, etc.) of the PPU(s), one or more performance capabilities (e.g., a number of cores, a number of threads, a processing speed, etc.) of the CPU(s), and/or so forth. Additionally, in some examples, the system(s) may perform additional and/or alternative processes to increase the performance of the session. For a first example, the system(s) may increase the number of cores of the PPU(s) that are allocated to the session. For a second example, the system(s) may increase the number of cores of the CPU(s) that are allocated to the session.

For more details about the offloading, the system(s) may use the PPU(s) to perform at least a first portion of the processing associated with the content data and/or use the CPU(s) to perform at least a second portion of the processing associated with the content data. For example, the system(s) may initially use the PPU(s) to generate and/or encode video data (e.g., with may represent a video stream) associated with the session. As described herein, the PPU(s) may use the input data when generating the video data. The system(s) may then use the PPU(s) to perform additional processing associated with the video data. For instance, in some examples, the system(s) may use the PPU(s) to process the video data using packetization. As described herein, packetization may include at least separating the video data into data packets. For example, if the video data represents frames of a first size (e.g., 20,000 bytes), then packetization may include separating the frames into data packets of a second size (e.g., 1,200 bytes).

Additionally, or alternatively, in some examples, the system(s) may use the PPU(s) to process the video data (e.g., the data packets associated with the video data) using FEC. As described herein, the system(s) may use FEC in order to control the errors in the data transmission between the system(s) and the client device. For example, FEC may include encoding the video data in a redundant manner, such as by using an error correction code (also known as an error correcting code). In some examples, performing FEC on the PPU(s) may reduce the latency associated with the FEC since FEC may include performing one or more matrix operations.

Additionally, or alternatively, in some examples, the system(s) may use the PPU(s) to encrypt at least a portion of the video data (e.g., the data packets associated with the video data) using one or more encryption techniques. As described herein, an encryption technique may include, but is not limited to, Advanced Encryption Standard (e.g., AES-128, AES-192, AES-256, etc.), Data Encryption Standard (DES), Rivest-Shamir-Alderman (RSA) encryption, line inversion encryption, adaptive streaming encryption, region specific streaming encryption, and/or any other encryption technique. In some examples, the PPU(s) receives and/or generates one or more encryption keys when performing the encryption. For example, during a session associated with an application, the system(s) may receive, from the client device, the encryption key that the PPU(s) uses to encrypt the video data.

In some examples, the system(s) may use the PPU(s) and/or the CPU(s) to process additional types of the content data. For instance, the system(s) may use the CPU(s) to process audio data, and/or metadata that is associated with the video data. As described herein, the CPU(s) may process the audio data using one or more similar and/or one or more additional processing techniques as compared to the PPU(s). For example, the CPU(s) may process the audio data using at least packetization, FEC, and/or encryption. However, in other examples, and similar to the processing of the video data, the system(s) may use the PPU(s) to perform at least a portion of the processing of the audio data.

In some examples, the system(s) may then use the CPU(s) and/or the PPU(s) to further process the content data before sending the content data to the client device. For example, the system(s) may use the CPU(s) to further process the processed video data and/or the processed audio data using packet pacing before sending the processed video data and/or the processed audio data to the client device. As described herein, packet pacing may include evenly spacing the data transmissions (e.g., the data packets) that are sent from the system(s) to the client device.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems implementing large language models, systems for performing conversational AI operations, systems for performing light transport simulation, systems for performing collaborative content creation for 3D assets, systems implemented at least partially using cloud computing resources, and/or other types of systems.

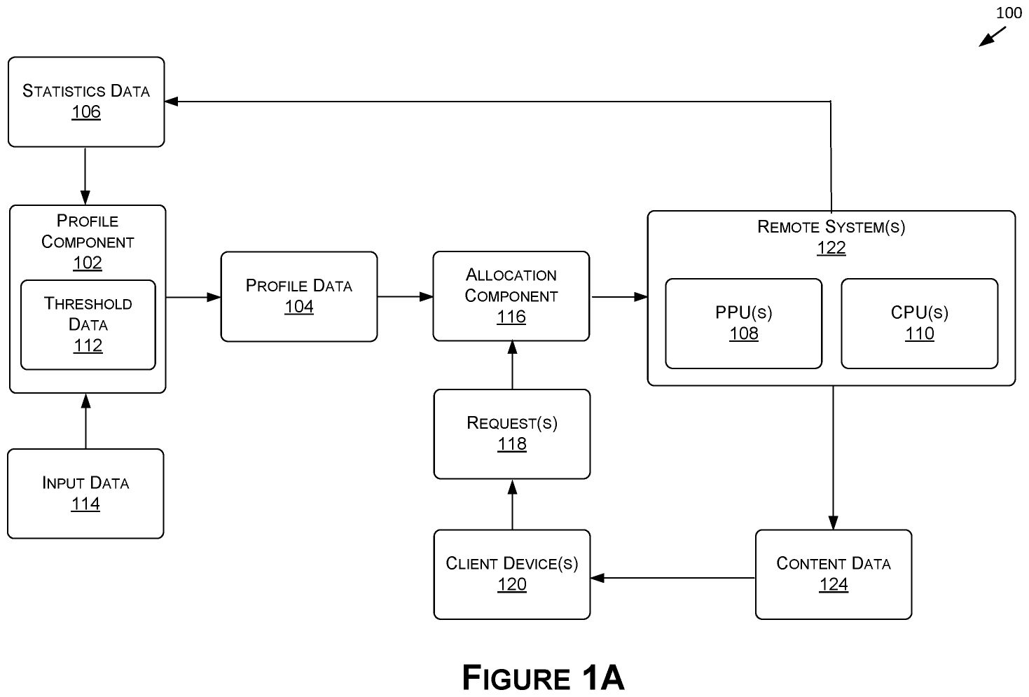

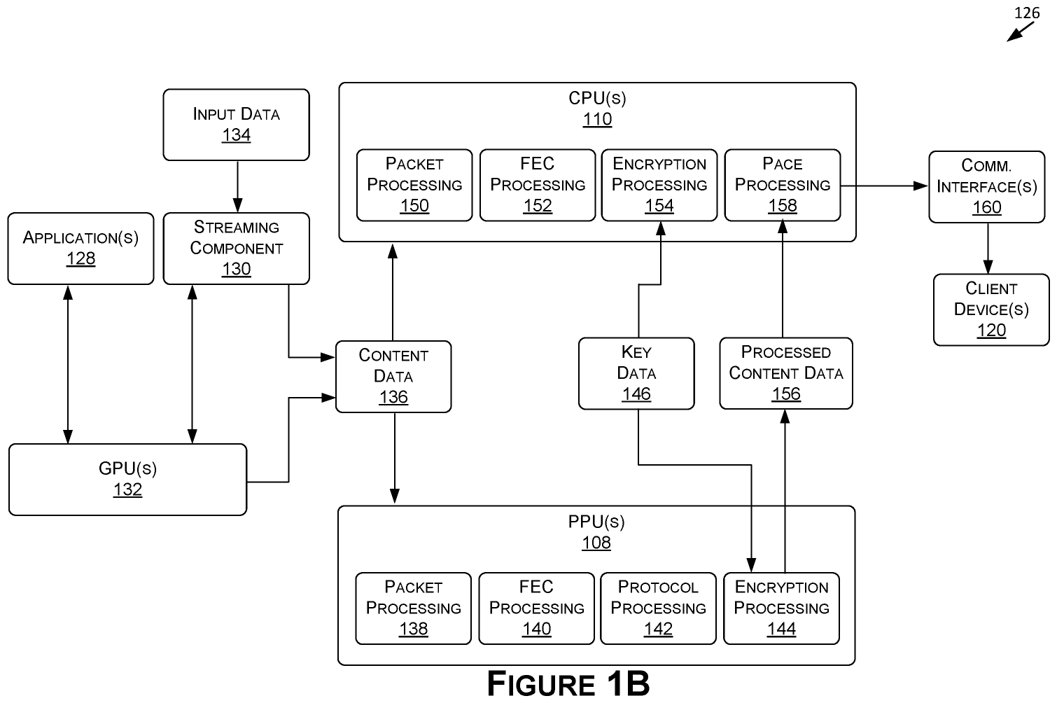

With reference to FIGS. 1A-1B, FIGS. 1A-1B illustrate example data flow diagrams for processes of determining whether to offload at least a portion of processing to one or more parallel processing units and then offloading those processes, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software, alone or in any combination. For instance, various functions may be carried out by a processor executing instructions stored in memory.

For instance, FIG. 1A illustrates an example data flow diagram for a process 100 of determining whether to offload at least a portion of processing to one or more parallel processing units, in accordance with some embodiments of the present disclosure. The process 100 may include a profile component 102 generating profile data 104 associated with an application using at least statistics data 106 associated with the application. The profile data 104 may represent a profile indicating information, such as processing information, associated with an application. As described herein, the information may include, but is not limited to, one or more first processes to be performed by one or more parallel processing units (PPU(s)) 108 (e.g., one or more graphics processing units, one or more hardware accelerators, etc.), one or more second processes to be performed by one or more central processing units (CPU(s)) 110, one or more processing metrics associated with the application, and/or any other information associated with the application. Additionally, a process may include, but is not limited to, packetization, forward error correction (FEC), encoding, encryption, pace processing, and/or any other type of process that may be performed on content data (e.g., video data, audio data, image data, location data, etc.). Furthermore, a processing metric may indicate a relationship between a configuration of one or more processors and a performance of a system (e.g., a processing stack) processing the content data.

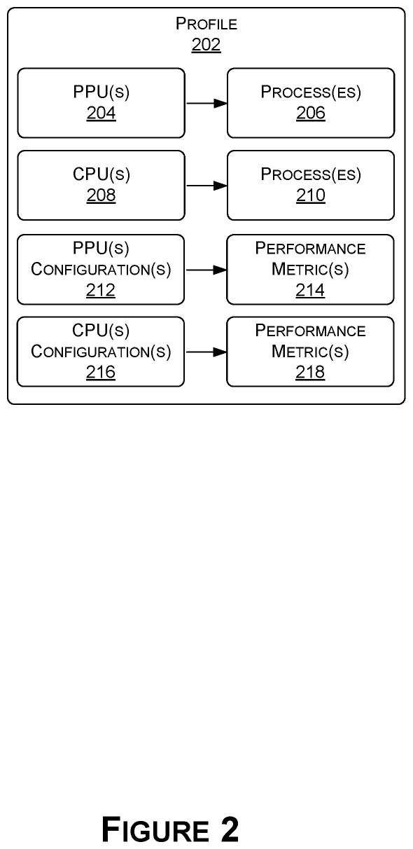

For instance, FIG. 2 illustrates an example of a profile 202 that may be used to allocate processes between the PPU(s) 108 and the CPU(s) 110, in accordance with some embodiments of the present disclosure. As shown, the profile 202 may associate a PPU identifier 204 with one or more first processes 206 and a CPU identifier 208 with one or more second processes 210. For a first example, the profile 202 may indicate that the PPU(s) 108 is to perform encryption (e.g., the first process(es) 206) while the CPU(s) 110 is to perform packetization, FEC, and pace processing (e.g., the second process(es) 210). For a second example, the profile 202 may indicate that the PPU(s) 108 is to perform packetization, FEC, coding, and encryption (e.g., the first process(es) 206) while the CPU(s) is to perform pace processing (e.g., the second process(es) 210). While these are just a couple examples of allocating processes between the PPU(s) 108 and the CPU(s) 110, in other examples, the profile 202 may indicate other allocations of processes between the PPU(s) 108 and the CPU(s) 110.

As further shown, the profile 202 may indicate one or more PPU configurations 212 that are associated with one or more performance metrics 214. As described herein, a PPU configuration 212 may be associated with a number of cores and/or one or more processes being performed by the PPU(s) 108. Additionally, a performance metric 214 may be associated with a number of errors (e.g., stutters, frame drops, etc.) over a period of time (e.g., a second, minute, etc.), a latency rate, a bandwidth rate, a frame rate, a minimum resolution, a maximum resolution, and/or any other performance metric. For example, a first PPU configuration 212 (e.g., using 2 cores) may be associated with a first number of errors (e.g., stutters, frame drops, etc.) over a period of time, a second PPU configuration 212 (e.g., using 3 cores) may be associated with a second number of errors over the period of time, a third PPU configuration 212 (e.g., 2 cores, with performing encryption) may be associated with a third number of errors over the period of time, a fourth PPU configuration 212 (e.g., 2 cores, with performing encryption and FEC) may be associated with a fourth number of errors over the period of time, and/or so forth.

The profile 202 may also indicate one or more CPU configurations 216 that are associated with one or more performance metrics 218. As described herein, a CPU configuration 216 may be associated with a number of cores and/or one or more processes being performed by the CPU(s) 110. Additionally, a performance metric 218 may be associated with a number of errors (e.g., stutters, frame drops, etc.) over a period of time (e.g., a second, minute, etc.), a latency rate, a bandwidth rate, a frame rate, a minimum resolution, a maximum resolution, and/or any other performance metric. For example, a first CPU configuration 216 (e.g., using 2 cores) may be associated with a first number of errors (e.g., stutters, frame drops, etc.) over a period of time, a second CPU configuration 216 (e.g., using 3 cores) may be associated with a second number of errors over the period of time, a third CPU configuration 216 (e.g., 2 cores, without performing encryption) may be associated with a third number of errors over the period of time, a fourth CPU configuration 216 (e.g., 2 cores, without performing encryption and FEC) may be associated with a fourth number of errors over the period of time, and/or so forth.

Referring back to the example of FIG. 1A, the statistics data 106 may represent one or more performance statistics associated with the application. In some examples, at least a portion of the performance statistic(s) may be determined based at least on one or more previous sessions associated with the application, which is described further herein. In some examples, at least a portion of the performance statistic(s) may be determined based at least on one or more tests performed for the application. In any example, a performance statistic may include, but is not limited to, an amount (e.g., percentage, number of cores, etc.) of a PPU utilized, an amount (e.g., percentage, number of cores, etc.) of a CPU utilized, an amount (e.g., percentage) of a PPU utilized by a specific process, an amount (e.g., percentage) of a CPU utilized by a specific process, a frame rate, a frame drop rate, a network bandwidth, a latency rate, a minimum resolution, a maximum resolution, and/or any other processing statistic that may be measured for a session of an application.

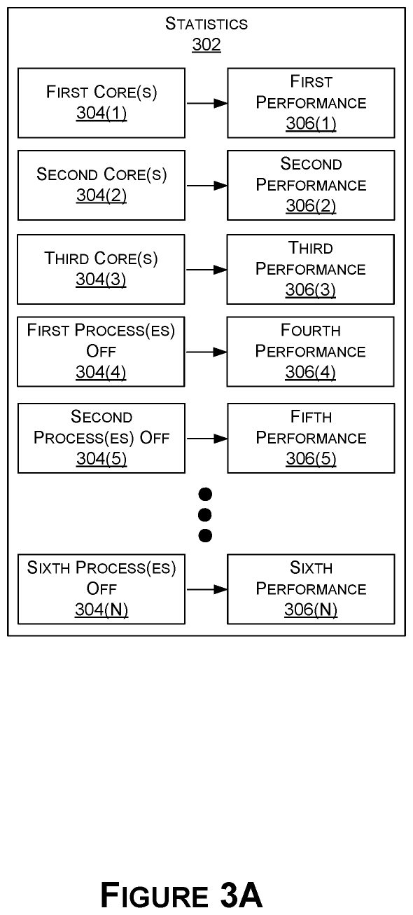

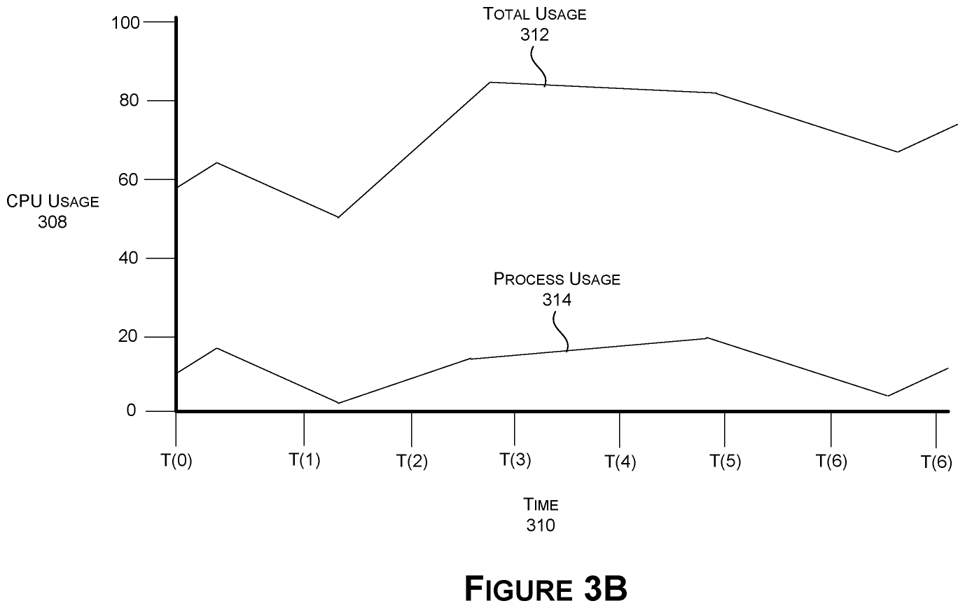

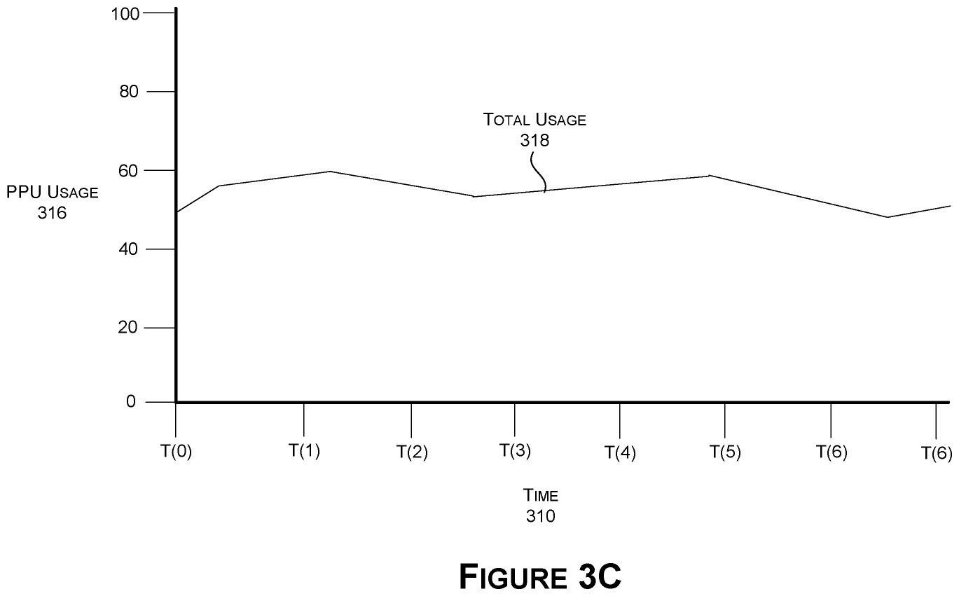

For instance, FIGS. 3A-3C illustrate examples of performance metrics associated with an application, in accordance with some embodiments of the present disclosure. As shown by the example of FIG. 3A, statistics 302 may be associated with one or more processors (e.g., the CPU(s) 110, the PPU(s) 108, etc.) of a processing stack. As shown, the statistics 302 associate various processor configurations 304(1)-(N) with various performances 306(1)-(N). A performance 306(1)-(N) may include, but is not limited to, an amount (e.g., percentage, number of cores, etc.) of a PPU utilized, an amount (e.g., percentage, number of cores, etc.) of a CPU utilized, an amount (e.g., percentage) of a PPU utilized by a specific process, an amount (e.g., percentage) of a CPU utilized by a specific process, a frame rate, a frame drop rate, a network bandwidth, a latency rate, a minimum resolution, a maximum resolution, and/or any other processing statistic that may be measured for a session of an application.

For instance, the statistics 302 may associate the processor using a first number of cores 304(1) (e.g., 2 cores) with the first performance 306(1) (e.g., a first number of stutters), the processor using a second number of cores 304(2) (e.g., 3 cores) with the second performance 306(2) (e.g., a second number of stutters), the processor using a third number of cores 304(3) (e.g., 4 cores) with the third performance 306(3) (e.g., a third number of stutters), the processor performing a first number of processes 304(4) (e.g., packetization, FED, and encryption) with the fourth performance 306(4) (e.g., a fourth number of stutters), the processor performing a second number of processes 304(5) (e.g., packetization and FED) with the fifth performance 306(5) (e.g., a fifth number of stutters), and the processor performing a third number of processes 304(N) (e.g., packetization) with the sixth performance 306(6) (e.g., a sixth number of stutters).

FIG. 3B illustrates an example of CPU usage 308 that occurs for a stream of an application over a period of time 310. As shown, the example of FIG. 3A illustrates both a total usage 312 caused by the stream as well as a process usage 314 from a specific process, such as packetization, FEC, encryption, and/or so forth. FIG. 3C then illustrates an example of PPU usage 316 that occurs for the stream of an application over the period of time 310. As shown, the example of FIG. 3C illustrates a total usage 318 caused by the stream.

Referring back to the example of FIG. 1, the profile component 102 may use one or more techniques to generate the profile using the statistics data 106. For example, one or more users (e.g., one or more developers) may analyze the performance statistics represented by the statistics data 106. Based at least on the analysis, the user(s) may determine which processes should be performed by the PPU(s) 108 and/or which processes should be performed by the CPU(s) 110. In such an example, the user(s) may use one or more performance thresholds when making the decisions, where the performance thresholds are represented by threshold data 112. As described herein, a performance threshold may include, but is not limited to, an error threshold (e.g., a number of stutters per period of time, a number of frame drops per period of time, etc.), a PPU utilization threshold (e.g., a maximum number of the PPU(s) 108 cores, a maximum usage percentage of the PPU(s) 108, etc.), a CPU utilization threshold (e.g., a maximum number of the CPU(s) 110 cores, a maximum usage percentage of the CPU(s) 110, etc.), a network bandwidth threshold, a latency threshold, a minimum resolution threshold, a maximum resolution threshold, and/or any other threshold.

For instance, the user(s) may determine the first process(es) to allocate to the PPU(s) 108 and/or the second process(es) to allocate to the CPU(s) 110 such that the overall performance of streaming the application satisfies one or more of these performance thresholds. The profile component 102 may then receive input data 114 representing the first process(es) to allocate to the PPU(s) 108 and/or the second process(es) to allocate to the CPU(s) 110. Additionally, the profile component 102 may generate the profile data 104 such that the profile indicates the first process(es) to allocate to the PPU(s) 108 and/or the second process(es) to allocate to the CPU(s) 110.

Additionally, or alternatively, in some examples, the profile component 102 may process the statistics data 106 and, based at least on the processing, determine the first process(es) to allocate to the PPU(s) 108 and/or the second process(es) to allocate to the CPU(s) 110. In such examples, the profile component 102 may use one or more of the performance thresholds when making the determinations. For instance, the profile component 102 may determine the first process(es) to allocate to the PPU(s) 108 and/or the second process(es) to allocate to the CPU(s) 110 such that a performance associated with streaming the application satisfies the performance threshold(s).

For a first example, and using the example of FIG. 3A, the statistics 302 may associate 2 cores of the CPU(s) 110 with 38 stutters per minute, 3 cores of the CPU(s) 110 with 10 stutters per minute, 4 cores of the CPU(s) 110 with 5 stutters per minute, 2 cores of the CPU(s) 110 without performing encryption with 18 stutters per minute, and 2 cores of the CPU(s) 110 without performing encryption and FEC with 16 stutters per minute. As such, if a first performance threshold indicates a maximum of 20 stutters per minute and a second performance threshold indicates a maximum of 2 cores, then the profile component 102 may determine to offload the encryption and/or offload the encryption and the FEC to the PPU(s) 108. This way, the profile component 102 allocates the processes such that the performance of the stream will satisfy the performance thresholds (e.g., the CPU(s) 110 will use the maximum of 2 cores and the stutters per minute will be less than or equal to the 20 stutters per minute).

For a second example, and again using the example of FIG. 3A, the statistics 302 may associate 2 cores of the CPU(s) 110 with 60 frames per second, 3 cores of the CPU(s) 110 with 90 frames per second, 4 cores of the CPU(s) 110 with 120 frames per second, 2 cores of the CPU(s) 110 without performing encryption with 80 frames per second, and 2 cores of the CPU(s) 110 without performing encryption and FEC with 100 frames per second. As such, if a first performance threshold indicates a minimum of 90 frames per second and a second performance threshold indicates a maximum of 2 cores, then the profile component 102 may determine to offload the encryption and the FEC to the PPU(s) 108. This way, the profile component 102 allocates the processes such that the performance of the stream will satisfy the performance thresholds (e.g., the CPU(s) 110 will use the maximum of 2 cores and the frames per second will be equal to or greater than the 90 frames per second).

The process 100 may include an allocation component 116 using the profile data 104 in order to allocate the processes between the PPU(s) 108 and the CPU(s) 110. In some examples, such as when the profile indicates the first process(es) to allocate to the PPU(s) 108 and/or the second process(es) to allocate to the CPU(s) 110, the allocation component 116 may directly use these indications when allocating the processes. For example, and using the example of FIG. 2, if the profile 202 indicates that the PPU(s) 108 are to perform the first process(es) 206 and the CPU(s) 110 are to perform the second process(es) 210, then the allocation component 116 may use that information from the profile 202 to cause the PPU(s) 108 to perform the first process(es) 206 and cause the CPU(s) 110 to perform the second process(es) 210.

Additionally, or alternatively, in some examples, such as when the profile does not indicate the specific allocation of processes, the allocation component 116 may analyze the processing metrics represented by the profile data 104 and, based at least on the processing, determine the first process(es) to allocate to the PPU(s) 108 and/or the second process(es) to allocate to the CPU(s) 110. In such examples, and similar to the profile component 102, the allocation component 116 may use one or more of the performance thresholds when making the determinations. For instance, the allocation component 116 may determine the first process(es) to allocate to the PPU(s) 108 and/or the second process(es) to allocate to the CPU(s) 110 such that a performance associated with streaming the application satisfies the performance threshold(s).

For a first example, and again using the example of FIG. 2, the CPU(s) configuration(s) 216 that is associated with the performance metric(s) 218 from the profile 202 may associate 2 cores of the CPU(s) 110 with 38 stutters per minute, 3 cores of the CPU(s) 110 with 10 stutters per minute, 4 cores of the CPU(s) 110 with 5 stutters per minute, 2 cores of the CPU(s) 110 without performing encryption with 18 stutters per minute, and 2 cores of the CPU(s) 110 without performing encryption and FEC with 16 stutters per minute. As such, if a first performance threshold indicates a maximum of 20 stutters per minute and a second performance threshold indicates a maximum of 2 cores, then the allocation component 116 may determine to offload the encryption and/or offload the encryption and the FEC to the PPU(s) 108. This way, the allocation component 116 allocates the processes such that the performance of the stream will satisfy the performance thresholds (e.g., the CPU(s) 110 will use the maximum of 2 cores and the stutters per minute will be less than or equal to the 20 stutters per minute).

For a second example, and again using the example of FIG. 2, the PPU(s) configuration(s) 212 that is associated with the performance metric(s) 214 from the profile 202 may associate 2 cores of the PPU(s) 108 with 30 stutters per minute, 3 cores of the PPU(s) 108 with 8 stutters per minute, 4 cores of the PPU(s) 108 with 3 stutters per minute, 2 cores of the PPU(s) 108 with performing encryption and FEC with 35 stutters per minute, and 2 cores of the PPU(s) 108 with performing encryption with 34 stutters per minute. As such, if a first performance threshold indicates a maximum of 30 stutters per minute and a second performance threshold indicates a maximum of 2 cores, then the allocation component 116 may determine not to offload the encryption and/or the FEC to the PPU(s) 108. This way, the allocation component 116 allocates the processes such that the performance of the stream will satisfy the performance thresholds.

In some examples, the profile component 102 and/or the allocation component 116 may use additional and/or alternative characteristics when determining whether to offload processing. For example, the profile component 102 and/or the allocation component 116 may use a number of sessions currently being executed by the PPU(s) 108, a number of sessions currently being executed by the CPU(s) 110, a number cores of the PPU(s) 108 that the application requires, a number of cores of the CPU(s) 110 that the application requires, one or more performance capabilities (e.g., a number of cores, a number of threads, a processing speed, etc.) of the PPU(s) 108, one or more performance capabilities (e.g., a number of cores, a number of threads, a processing speed, etc.) of the CPU(s) 110, and/or so forth. Additionally, in some examples, the profile component 102 and/or the allocation component 116 may perform additional and/or alternative processes to increase the performance of the session. For a first example, the profile component 102 and/or the allocation component 116 may increase the number of cores of the PPU(s) 108 that are allocated to the session. For a second example, the profile component 102 and/or the allocation component 116 may increase the number of cores of the CPU(s) 110 that are allocated to the session.

For example, the PPU(s) 108 may be performing one or more processes for one or more first sessions of one or more applications, where the process(es) are associated with one or more first characteristics (e.g., a first frame rate, a first resolution, a first type of encryption, a first type of encoding, etc.). As such, if the allocation component 116 is allocating processes associated with a second session of an application, where the second session is associated with one or more second characteristics (e.g., a second frame rate, a second resolution, a second type of encryption, a second type of encoding, etc.), then the allocation component 116 may not offload a similar process(es) to the PPU(s) 108. In some examples, the allocation component 116 may not offload the process(es) since such offloading may cause context switching on the PPU(s) 108, which may degrade the performance of the streaming.

In some examples, the allocation component 116 may determine the allocations such that the processing does not require constant switching between the PPU(s) 108 and the CPU(s) 110. For example, if the allocation component 116 determines that the PPU(s) 108 is to perform one or more processes, such as encryption, then the allocation component 116 may further determine that the CPU(s) 110 is to perform the remainder of the processing once the PPU(s) 108 is finished with the allocated processing. In other words, in some examples, the allocation component 116 may determine the allocation such that the data is not passed multiple times to the PPU(s) 108 for processing.

In some examples, the allocation component 116 may determine the allocation based at least on the occurrence of one or more events. For a first example, and as illustrated in the example of FIG. 1A, the allocation component 116 may determine the allocation based on receiving a request 118 from a client device 120, where the request 118 is to start a session associated with the application. For a second example, the allocation component 116 may determine the allocation based on one or more additional events, such as one or more remote systems 122 beginning one or more sessions associated with the application, a determination of one or more amounts of one or more resources associated with the PPU(s) 108 that are being used, a determination of one or more amounts of one or more resources of the CPU(s) 110 that are being used, and/or any other event.

The process 100 may include the remote system(s) 122 processing a session of the application based at least on the allocation of the processes, which is described in more detail herein with regard to FIG. 1B. Additionally, based at least on the processing, the process 100 may include the remote system(s) 122 generating and/or outputting content data 124 associated with the session. As shown, the content data 124 may be sent to the client device(s) 120 such that the client device(s) 120 may provide at least a portion of content represented by the content data 124 to one or more users.

As further illustrated in the example of FIG. 1A, the process 100 may include the remote system(s) 122 generating and/or outputting additional statistics data 106 based at least on one or more additional sessions of the application. For example, the additional statistics data 106 may represent one or more performance statistics associated with the one or more additional sessions of the application. Additionally, the profile component 102 may then use the additional statistics data 106 to update the profile associated with the application. For example, the profile component 102 may update the first process(es) to be performed by PPU(s) 108, the second process(es) to be performed by CPU(s) 110, the processing metric(s) associated with the application, and/or any other information represented by the profile data 104 based at least on the additional statistics data 106 and using one or more of the processes described herein.

In some examples, the profile component 102 may update the profile data 104 based on the occurrence of one or more additional and/or alternative events. For example, the profile component 102 may update the profile based on the application being updated, an elapse of a period of time (e.g., each day, week, month, year, etc.), the statistics data 106 being updated, input from a user, and/or any other event.

FIG. 1B illustrates an example data flow diagram for a process 126 of processing content data using one or more graphics processing units, in accordance with some embodiments of the present disclosure. The process 126 may include executing an application 128. As described herein, the application 128 may include, but is not limited to, a gaming application, a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, and/or any other type of application. For example, the application 128 may include a gaming application that is being provided by one or more remote servers, such as the remote system(s) 122 and/or one or more application servers 1302, to the client device(s) 120 (which may represent, and/or include, one or more client devices 1304). In such an example, the remote server(s) may be providing an application session to the client device(s) 120 via one or more networks.

The process 126 may include a streaming component 130 that provides data to one or more graphics processing units (GPU(s)) 132. For instance, the streaming component 130 may receive data from the client device(s) 120, such as input data 134 representing one or more inputs. In some examples, the streaming component 130 may then process the input data 134 using one or more processes, such as to update the application session based on the input(s). The streaming component 130 may then send the data to the GPU(s) 132 in order to cause the GPU(s) 132 to generate one or more renderings associated with the application session. For instance, the GPU(s) 132 may use the data to generate at least a portion of content data 136 (e.g., video data, audio data, etc.) associated with the application session, where the content data 136 represents one or more frames (e.g., a video stream) rendered by the GPU(s) 132. In some examples, the GPU(s) 132 may perform further processing on the content data 136. For example, the GPU(s) 132 may encode the content data 136, using one or more video encoding techniques, in order to transform the content data 136 from one video format to another video format.

The process 126 may include using the PPU(s) 108 to further process the content data 136 (e.g., the encoded content data 136). In some examples, the GPU(s) 132 used to generate and/or encode the content data 136 may include the same PPU(s) 108 used to further process the content data 136. In other examples, one or more of the GPU(s) 132 used to generate and/or encode the content data 136 may be different than one or more of the PPU(s) 108 used to further process the content data 136.

For instance, and as shown, in some examples, the process 126 may include the PPU(s) 108 processing the content data 136 using one or more processes 138 associated with packetization. As described herein, packetization may include breaking the content data 136 into chunks, which may be referred to as data packets. For example, if the content data 136 represents frames that include a first data size (e.g., 20,000 bytes), then the packetization may include breaking the frames into a number of data packets that include a second data size (e.g., 1,200 bytes) that is less than the first data size. In some examples, a data packet may be composed of one or more elements. For example, a data packet may include, but is not limited to, a header that includes information (e.g., an origin, a destination, a length, a packet number, etc.) associated with the data packet, a payload that includes the portion of the content data 136, and/or a trailer that indicates an end of the data packet and/or includes error detection and correction information.

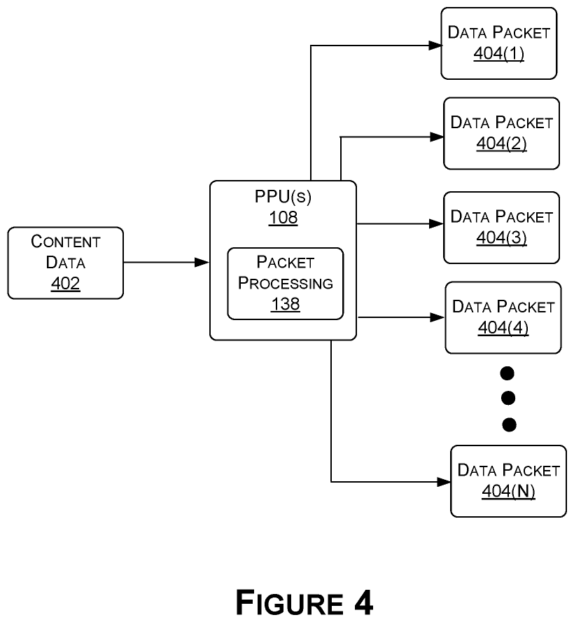

For instance, FIG. 4 illustrates an example of the PPU(s) 108 performing packet processing 138 on content data 402 (which may represent, and/or include, the content data 136), in accordance with some embodiments of the present disclosure. As shown, the PPU(s) 108 may process the content data 402 using the packet processing 138 and, based at least on the processing, generate data packets 404(1)-(N) (also referred to singularly as “data packet 404” or in plural as “data packets 404”) associated with the content data 402. In some examples, each of the data packets 404 may include approximately a same amount of data. In some examples, one or more of the data packets 404 may include an amount of data that differs from one or more other data packets 404. Still, in some examples, the PPU(s) 108 may generate the data packets 404 to represent portions of the content data 402. For example, the packet processing 138 may generate groups of data packets 404, where a group of data packets 404 includes data for one or more frames represented by the content data 402.

Referring back to the example of FIG. 1B, in some examples, the process 126 may include the PPU(s) 108 processing the content data 136 using one or more processes 140 associated with FEC. As described herein, the PPU(s) 108 may use FEC in order to control (mitigate) the errors and lost packets in the data transmission with the client device(s) 120. For example, FEC may include encoding the content data 136 (e.g., the data packets) in a redundant manner, such as by using an error correction code. This redundancy may then allow the client device(s) 120 to not only detect lost packets that may occur with the transmission of the content data 136, but also compensate for one or more of the errors. In some examples, the FEC processing 140 that is performed on the content data 136 may include one or more matrix operations. In such examples, the PPU(s) 108 may be capable of performing the matrix operation(s) faster than the CPU(s) 110 described herein. For example, such is if the FEC processing 140 includes performing multiple matrix operations, the PPU(s) 108 may be capable of performing the matrix operations in parallel. As described herein, this may reduce the latency associated with processing the content data 136.

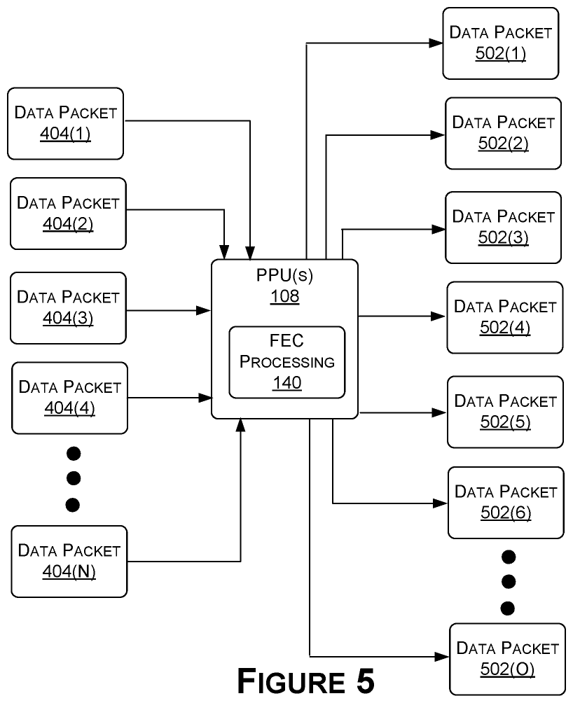

For instance, FIG. 5 illustrates an example of the PPU(s) 108 processing the content data 402 using FEC processing 140, in accordance with some embodiments of the present disclosure. As shown, the PPU(s) 108 may process the data packets 404 associated with the content data 402 using the FEC processing 140. Based at least on the processing, the PPU(s) 108 may generate processed data packets 502(1)-(O) (also referred to singularly as “data packet 502” or in plural as “data packets 502”). In some examples, a first number of the data packets 404 is the same as a second number of the data packets 502. In some examples, the first number of the data packets 404 is different than the second number of the data packets 502. For instance, the second number of the data packets 502 may depend on the first number of the data packets 404 and a rate associated with the FEC processing 140. For a first example, if the first number of the data packets 404 includes 20 data packets and the rate associated with the FEC processing 140 is 20%, then the second number of the data packets 502 may include 24 data packets. For a second example, if the first number of the data packets 404 includes 100 data packets and the rate associated with the FEC processing 140 is 30%, then the second number of the data packets 502 may include 132 data packets.

Referring back to the example of FIG. 1B, in some examples, the process 126 may include the PPU(s) 108 processing the content data 136 using one or more processes 142 associated with one or more transport protocols. As described herein, a network protocol may include, but is not limited to, Real-Time Transport Protocol (RTP), Transmission Control Protocol (TCP), User Datagram Protocol (UDP), Session Announcement Protocol (SAP), Session Description Protocol (SDP), and/or any other network protocol. For instance, the protocol processing 142 may include encoding the content data 136 according to the transport protocol(s). For example, if the network protocol(s) incudes RTP, then the protocol processing 142 may include encoding the data packets associated with the content data 136 based on the RTP. For instance, based at least on the processing, the data packets may include one or more fields associated with the RTP.

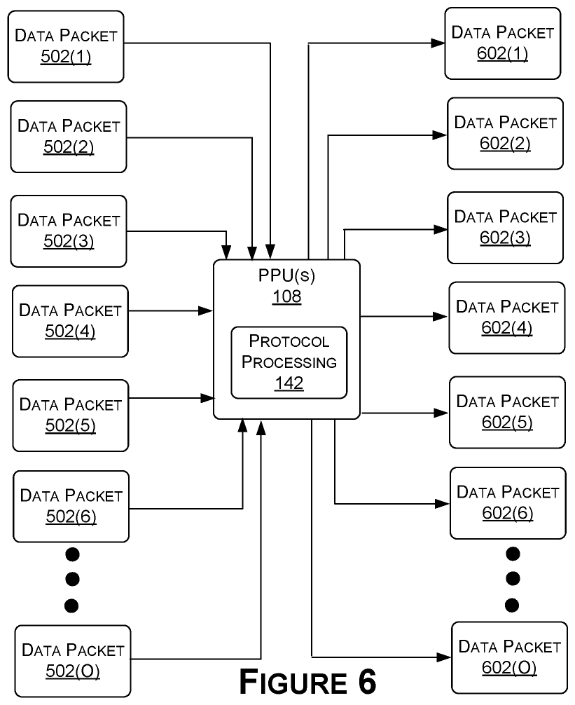

For instance, FIG. 6 illustrates an example of the PPU(s) 108 encoding the content data 402 using protocol processing 142, in accordance with some embodiments of the present disclosure. As shown, the PPU(s) 108 may process the data packets 502 associated with the content data 402 using the protocol processing 142. Based at least on the processing, the PPU(s) 108 may generate processed data packets 602(1)-(O) (also referred to singularly as “data packet 602” or in plural as “data packets 602”). As described herein, the protocol processing 142 of the data packets 502 may include encoding the data packets 502 according to a specific network protocol. For example, if the network protocol includes RTP, then the data packets 602 may include a number of fields such as, but not limited to, a version field, a padding field, an extension field, a number of identifiers field, a payload type field, a sequence number field, a timestamp field, a synchronization source identifier field, a contributing source identifier field, a header extension field, and/or any other field associated with the RTP.

Referring back to the example of FIG. 1B, in some examples, the process 126 may include the PPU(s) 108 processing the content data 136 using one or more processes 144 associated with encryption. As described herein, the encryption performed during the encryption processing 144 may include, but is not limited to, AES (e.g., AES-128, AES-192, AES-256, etc.), DES, RSA encryption, line inversion encryption, adaptive streaming encryption, region specific streaming encryption, and/or any other encryption technique. For a first example, the PPU(s) 108 may process the content data 136 using the encryption processing 144 in order to generate encrypted content data 136. For a second example, such as when the content data 136 is processed using the packet processing 138, the PPU(s) 108 may process the data packets associated with the content data 136 in order to generate encrypted data packets.

As shown by the example of FIG. 1B, the encryption processing 144 may use an encryption key, which is represented in FIG. 1B by key data 146, in order to encrypt the content data 136. In some examples, the encryption key is associated with the application session between the remote server(s) and the client device(s) 120. For instance, the PPU(s) 108 may receive, generate, and/or retrieve a respective new encryption key for one or more (e.g., each) application session. In some examples, the client device(s) 120 associated with the application session may provide the encryption key that the PPU(s) 108 uses during the application session. For instance, at the start of the application session, the client device(s) 120 may send the key data 146 to the remote server(s) so that the remote server(s) is able to provide the PPU(s) 108 with the encryption key. Still, in some examples, and as described in more detail herein, the CPU(s) 110 may use the same encryption key when encrypting data associated with the application session.

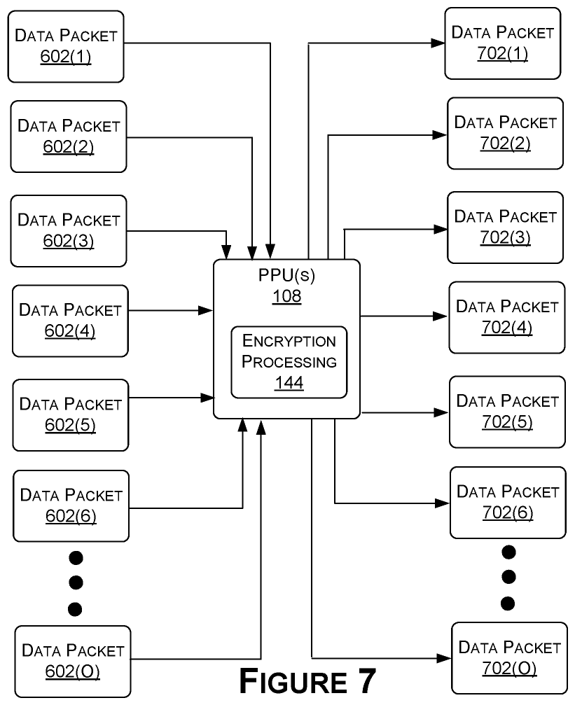

For instance, FIG. 7 illustrates an example of the PPU(s) 108 encrypting the content data 402, in accordance with some embodiments of the present disclosure. As shown, the PPU(s) 108 may process the data packets 602 associated with the content data 402 using the encryption processing 144. Based at least on the processing, the PPU(s) 108 may generate encrypted data packets 702(1)-(O) (also referred to singularly as “encrypted data packet 702” or in plural as “encrypted data packets 702”). While the example of FIG. 7 illustrates the encrypted data packets 702 as including a same number of data packets as the data packets 602, in other examples, the encrypted data packets 702 may include less or more data packets as compared to the data packets 602.

Referring back to the example of FIG. 1B, while the example of FIG. 1B illustrates the PPU(s) 108 processing the content data 136 using the packet processing 138, the FEC processing 140, the protocol processing 142, and the encryption processing 144, in other examples, and based at least on the allocation of the processing, the PPU(s) 108 may only process the content data 136 using one or more of the packet processing 138, the FEC processing 140, the protocol processing 142, and the encryption processing 144 (e.g., the PPU(s) 108 may not process the content data 136 using the protocol processing 142). Additionally, in some examples, the PPU(s) 108 may process the content data 136 using one or more additional and/or alternative data processing techniques.

The process 126 may include the streaming component 130 outputting at least a portion of the content data 136. For example, the portion of the content data 136 output by the GPU(s) 132 may include video data and the portion of the content data 136 output by the streaming component 130 may include audio data associated with the video data. For example, the video data may represent the frames rendered for the application session and the audio data may represent the sound that is to be output while displaying the frames. In some examples, the audio data is synchronized with the video data using one or more techniques, such as timestamps indicating times for outputting the sound represented by the audio data and timestamps indicating times for displaying the frames represented by the video data. In some examples, the streaming component 130 may encode the content data 136, similar to the GPU(s) 132.

The process 126 may include the CPU(s) 110 processing the content data 136 output by the streaming component 130. For instance, and as shown, in some examples, the process 126 may include the CPU(s) 110 processing the content data 136 using one or more processes 150 associated with packetization. As described herein, packetization may include breaking the content data 136 into chunks, which may be referred to as data packets. For example, the packetization may include breaking the content data 136 into a number of data packets that include a data size such as, but not limited to, 500 bytes, 1,000 bytes, 1,200 bytes, 1,500 bytes, and/or any other size. In some examples, the data packets generated by the CPU(s) 110 during the packet processing 150 may include a same size as the data packets generated by the PPU(s) 108 during the packet processing 138. In some examples, one or more of the data packets generated by the CPU(s) 110 during the packet processing 150 may include a different size than one or more of the data packets generated by the PPU(s) 108 during the packet processing 138.

In some examples, a data packet may be composed of one or more elements. For example, a data packet may include, but is not limited to, a header that includes information (e.g., an origin, a destination, a length, a packet number, etc.) about the data packet, a payload that includes the portion of the content data 136, and/or a trailer which indicates the end of the data packet and/or includes error detection and correction information.

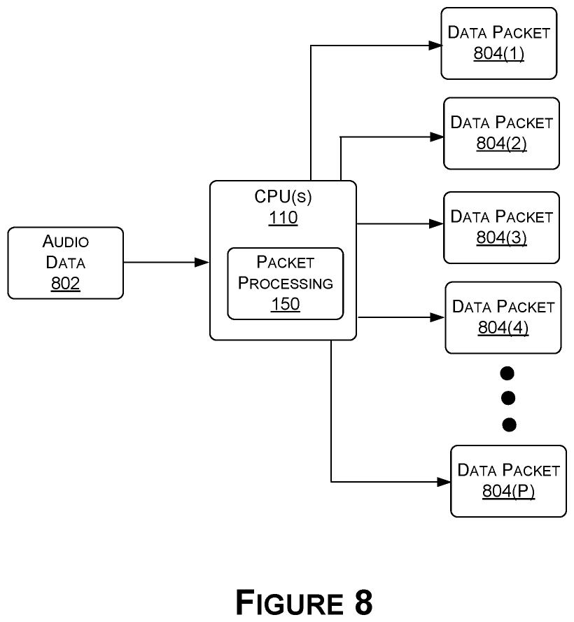

For instance, FIG. 8 illustrates an example of the CPU(s) 110 processing content data 802 (which may represent, and/or include, the content data 136) using packetization, in accordance with some embodiments of the present disclosure. As shown, the CPU(s) 110 may process the content data 802 using the packet processing 150 and, based at least on the processing, generate data packets 804(1)-(P) (also referred to singularly as “data packet 804” or in plural as “data packets 804”) associated with the content data 802. In some examples, each of the data packets 804 may include approximately a same amount of data. In some examples, one or more of the data packets 804 may include an amount of data that differs from one or more other data packets 804.

Referring back to the example of FIG. 1B, in some examples, the process 126 may include the CPU(s) 110 processing the content data 136 (e.g., the data packets) using one or more processes 152 associated with FEC. As described herein, the CPU(s) 110 may use the FEC processing 152 in order to control the errors in the data transmission with the client device(s) 120. For example, the FEC processing 152 may include encoding the content data 136 (e.g., the data packets) in a redundant manner, such as by using an error correction code. This redundancy may then allow the client device(s) 120 to not only detect errors (e.g., lost packets) that may occur with the transmission of the content data 136, but also compensate for one or more of the errors. In some examples, the FEC processing 152 that is performed by the CPU(s) 110 may be similar to the FEC processing 140 that is performed by the PPU(s) 108. In some examples, the FEC processing 152 that is performed by the CPU(s) 110 may be different than the FEC processing 140 that is performed by the PPU(s) 108.

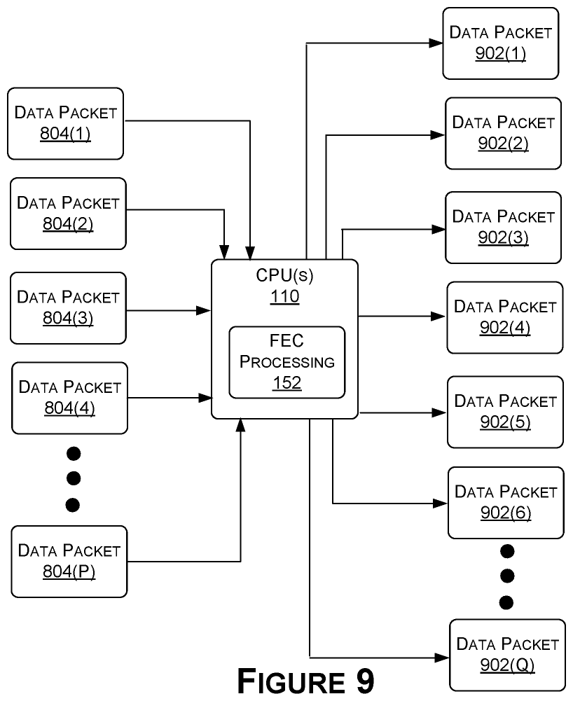

For instance, FIG. 9 illustrates an example of the CPU(s) 110 processing the content data 802 using the FEC processing 152, in accordance with some embodiments of the present disclosure. As shown, the CPU(s) 110 may process the data packets 804 associated with the content data 802 using the FEC processing 152. Based at least on the processing, the CPU(s) 110 may generate processed data packets 902(1)-(Q) (also referred to singularly as “data packet 902” or in plural as “data packets 902”). In some examples, a first number of the data packets 804 is the same as a second number of the data packets 902. In some examples, the first number of the data packets 804 is different than the second number of data packets 902. For instance, the second number of the data packets 902 may depend on the first number of the data packets 804 and a rate associated with the FEC processing 152. For a first example, if the first number of the data packets 804 includes 20 data packets and the rate associated with the FEC processing 152 is 20%, then the second number of the data packets 902 may include 24 data packets. For a second example, if the first number of the data packets 804 includes 100 data packets and the rate associated with the FEC processing 152 is 30%, then the second number of the data packets 902 may include 132 data packets.

Referring back to the example of FIG. 1B, in some examples, the process 126 may include the CPU(s) 110 processing the content data 136 (e.g., the data packets) using one or more processes 154 associated with encryption. As described herein, the encryption performed during the encryption processing 154 may include, but is not limited to, AES (e.g., AES-128, AES-192, AES-256, etc.), DES, RSA encryption, line inversion encryption, adaptive streaming encryption, region specific streaming encryption, and/or any other encryption technique. For a first example, the CPU(s) 110 may process the content data 136 using the encryption processing 154 in order to generate encrypted content data 136. For a second example, such as when the content data 136 is processed using the packet processing 150, the CPU(s) 110 may process the data packets associated with the content data 136 in order to generate encrypted data packets.

As shown by the example of FIG. 1B, the encryption processing 154 may use an encryption key, with is also represented by key data 146, in order to encrypt the content data 136. As described herein, in some examples, the encryption key is associated with the application session between the remote server(s) and the client device(s) 120. For instance, the CPU(s) 110 may generate and/or retrieve a respective new encryption key for one or more (e.g., each) application session. As described herein, in some examples, the client device(s) 120 associated with the application session may provide the encryption key that the CPU(s) 110 uses during the application session. For instance, at the start of the application session, the client device(s) 120 may send the key data 146 to the remote server(s) so that the remote server(s) is able to provide the CPU(s) 110 with the encryption key. Still, in some examples, the CPU(s) 110 may use the same encryption key as the PPU(s) 108.

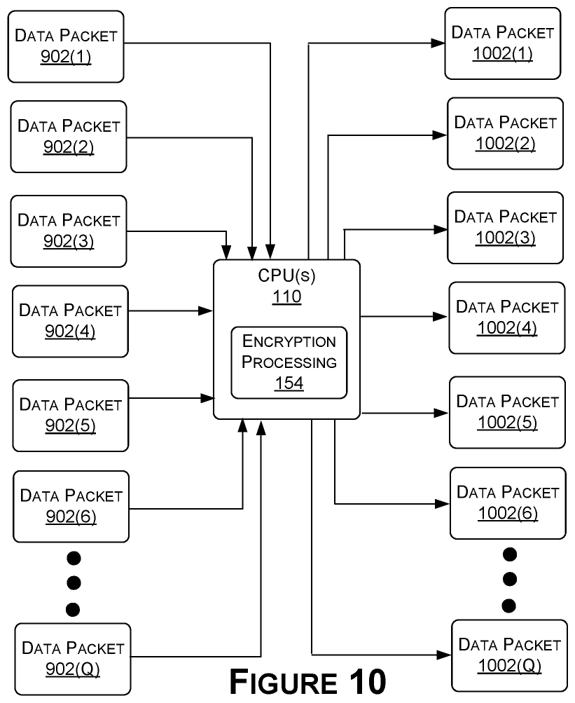

For instance, FIG. 10 illustrates an example of the CPU(s) 110 encrypting the content data 802, in accordance with some embodiments of the present disclosure. As shown, the CPU(s) 110 may process the data packets 902 associated with the content data 802 using the encryption processing 154. Based at least on the processing, the CPU(s) 110 may generate encrypted data packets 1002(1)-(Q) (also referred to singularly as “encrypted data packet 1002” or in plural as “encrypted data packets 1002”). While the example of FIG. 10 illustrates the encrypted data packets 1002 as including a same number of data packets as the data packets 902, in other examples, the encrypted data packets 1002 may include less or more data packets as compared to the data packets 902.

Referring back to the example of FIG. 1B, the process 126 may include the CPU(s) 110 processing the content data 136 processed by the PPU(s) 108, which is represented by processed content data 156, and the content data 136 processed by the CPU(s) 110 using pace processing 158. In some examples, the pace processing 158 may include packet pacing, where the CPU(s) 110 causes the data packets to be substantially evenly sent to the client device(s) 120 using one or more communication interfaces 160 (which may represent, and/or include, a communication interface 1318). However, in other examples, the CPU(s) 110 may use additional and/or alternative processes for sending the processed content data 156 and/or the processed content data 136 to the client device(s) 120.

In some examples, the process 126 may continue to repeat as the remote server(s) continues to provide content data to the client device(s) 120 during the application session(s). For example, during an application session with a client device 120, the client device 120 may continue to generate and send input data 134 to the remote server(s), where the input data 134 represents one or more inputs received by the client device 120. Based on receiving the input data 134, the remote server(s) may perform the processes described herein to generate the content data 136 based at least on the input data 134. The remote server(s) may then process the content data 136 using one or more of the processes described herein. Additionally, the remote server(s) may send the processed content data 136 and/or the processed content data 156 to the client device 120.

In some examples, the packet processing 138, the FEC processing 140, the protocol processing 142, the encryption processing 144, the packet processing 150, the FEC processing 152, the encryption processing 154, and/or the pace processing 158 may represent hardware and/or software components, engines, modules, and/or the like that perform the processes described herein. For a first example, the PPU(s) 108 may include one or more hardware components and/or one or more software components that perform the packet processing 148, the FEC processing 140, the protocol processing 142, and/or the encryption processing 144. For a second example, the CPU(s) 110 may include one or more hardware components and/or one or more software components that perform the packet processing 150, the FEC processing 152, the encryption processing 154, and/or the pace processing 158.

As described herein, by processing the content data (e.g., the content data 136, the content data 136, etc.) using the process 100 from the example of FIG. 1, the remote server(s) may provide one or more improvements. For a first example, the remote server(s) may be able to provide a greater number of application sessions (e.g., two application sessions, four applications sessions, etc.) to multiple client devices 120 using fewer PPU(s) 108 resources and/or fewer CPU(s) 110 resources (e.g., a fewer number of cores). For a second example, the remote server(s) may be able to provide better quality content streams to the client devices 120 during the applications sessions, such as content streams with greater frame rates and/or higher video resolutions.

Additionally, as described herein, the allocation component 116 may use one or more of the processes described herein to allocate the processing of the content data 136 between the PPU(s) 108 and the CPU(s) 110. For example, the allocation component 116 may determine whether the PPU(s) 108 is to process the content data 136 using the packet processing 138, the FEC processing 140, the protocol processing 142, and/or the encryption processing 144 and/or whether the CPU(s) 110 is to process the content data 136 using the packet processing 150, the FEC processing 152, the encryption processing 154, and/or the pace processing 158. In some examples, the allocation component 116 may further determine which portion of the content data 136 is processed using the first process(es) of the PPU(s) 108 and/or which portion of the content data 136 is processed using the second process(es) of the CPU(s) 110. For example, the allocation component 116 may determine whether the audio data, as represented by the content data 136, is processed using the first process(es) of the PPU(s) 108 and/or the second process(es) of the CPU(s) 110. Additionally, the allocation component 116 may determine whether the video data, as also represented by the content data 136, is processed using the first process(es) of the PPU(s) 108 and/or the second process(es) of the CPU(s) 110.

While the examples of FIGS. 1A-1B describe performing these processes to allocate processes associated with a single session of an application, in some examples, similar processes may be performed to allocate processes for multiple sessions of the application 128 and/or multiple sessions of multiple applications 128. In such examples, the allocations of the processes may differ for the sessions and/or between the applications. For a first example, the allocation component 116 may determine that the PPU(s) 108 is to perform one or more first processes and the CPU(s) 110 is to perform one or more second processes for a first session of an application 128. Additionally, the allocation component 116 may determine that the PPU(s) 108 is to perform one or more third processes and the CPU(s) 110 is to perform one or more fourth processes for a second session of the application 128. In such an example, one or more of the first process(es) may differ from one or more of the third process(es), one or more of the second process(es) may differ from one or more of the fourth process(es), one or more of the first process(es) may be similar to one or more of the fourth process(es), and/or one or more of the second process(es) may be similar to one or more of the third process(es).

For a second example, the allocation component 116 may determine that the PPU(s) 108 is to perform one or more first processes and the CPU(s) 110 is to perform one or more second processes for a first session of a first application 128. Additionally, the allocation component 116 may determine that the PPU(s) 108 is to perform one or more third processes and the CPU(s) 110 is to perform one or more fourth processes for a second session of a second application 128. In such an example, one or more of the first process(es) may be similar to one or more of the third process(es), one or more of the first process(es) may differ from one or more of the third process(es), one or more of the second process(es) may be similar to one or more of the fourth process(es), and/or one or more of the second process(es) may differ from one or more of the fourth process(es)

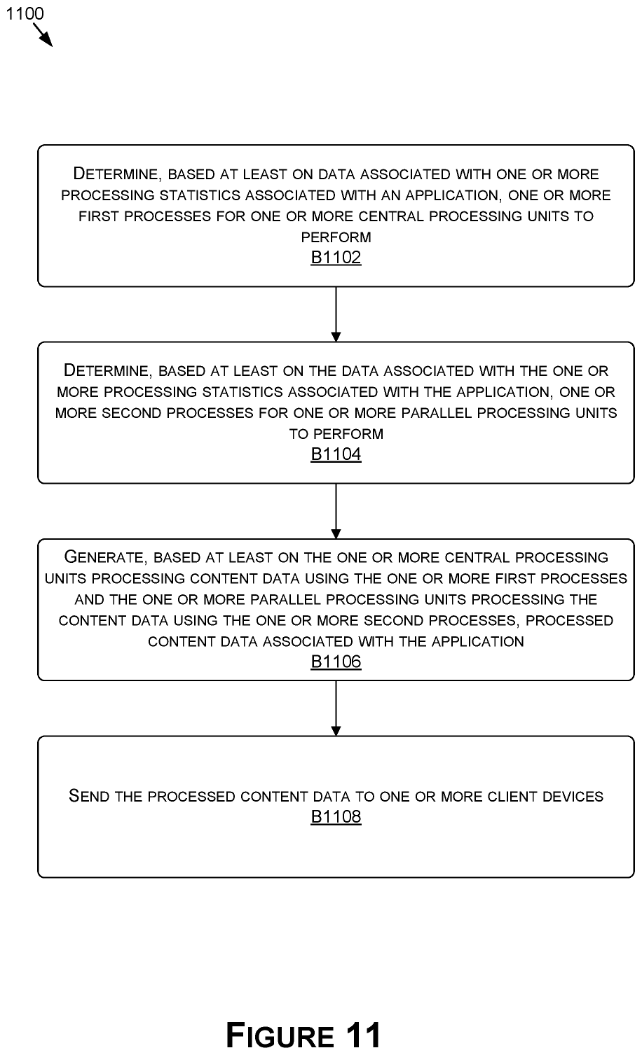

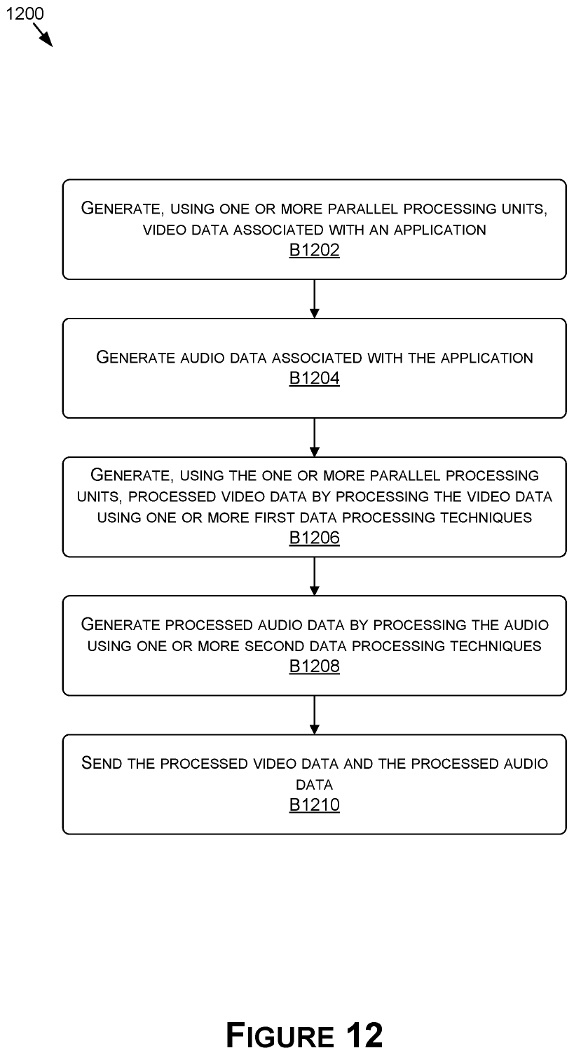

Now referring to FIGS. 11 and 12, each block of method 1100 and 1200, described herein, comprises a computing process that may be performed using any combination of hardware, firmware, and/or software. For instance, various functions may be carried out by a processor executing instructions stored in memory. The methods 1100 and 1200 may also be embodied as computer-usable instructions stored on computer storage media. The methods 1100 and 1200 may be provided by a standalone application, a service or hosted service (standalone or in combination with another hosted service), or a plug-in to another product, to name a few. In addition, the method 1100 and 1200 are described, by way of example, with respect to FIGS. 1A and 1B. However, the methods 1100 and 1200 may additionally or alternatively be executed by any one system, or any combination of systems, including, but not limited to, those described herein.

FIG. 11 is a flow diagram showing a method 1100 for offloading at least a portion of processing to one or more parallel processing units, in accordance with some embodiments of the present disclosure. The method 1100, at block B1102, may include determining, based at least on data associated with one or more processing statistics associated with an application, one or more first processes for one or more central processing units to perform. For instance, the allocation component 116 may use the profile data 104 to determine the first process(es) for the CPU(s) 110 to perform. As described herein, in some examples, the profile data 104 may indicate the first process(es) for the CPU(s) 110 to perform. In some examples, the profile data 104 may indicate one or more processing metrics associated with the PPU(s) 108 and/or the CPU(s) 110. In such examples, the allocation component 116 may analyze the processing metric(s) to determine the first process(es) for the CPU(s) 110 to perform.

The method 1100, at block B1104, may include determining, based at least on the data associated with the one or more processing statistics associated with the application, one or more second processes for one or more parallel processing units to perform. For instance, the allocation component 116 may use the profile data 104 to determine the second process(es) for the PPU(s) 108 to perform. As described herein, in some examples, the profile data 104 may indicate the second process(es) for the PPU(s) 108 to perform. In some examples, the profile data 104 may indicate the processing metric(s) associated with the PPU(s) 108 and/or the CPU(s) 110. In such examples, the allocation component 116 may analyze the processing metric(s) to determine the second process(es) for the PPU(s) 108 to perform.

The method 1100, at block B1106, may include generating, based at least on the one or more central processing units processing content data using the one or more first processes and the one or more parallel processing units processing the content data using the one or more second processes, processed content data associated with the application. For instance, the CPU(s) 110 may process at least a portion of the content data 136 using the first process(es) while the PPU(s) 108 process at least a portion of the content data 136 using the second process(es). Based at least on the processing, the content data 124 may be generated.

The method 1100, at block B1108, may include sending the processed content data to the one or more client devices. For instance, the content data 124 may be sent to the client device(s) 120.

FIG. 12 is a flow diagram showing a method 1200 for processing content data using one or more parallel processing units, in accordance with some embodiments of the present disclosure. The method 1200, at block B1202, may include generating, using one or more parallel processing units, video data associated with an application. For instance, the PPU(s) 108 may generate the video data (e.g., a portion of the content data 136) associated with the application 128. In some examples, the PPU(s) 108 generates the video data based at least on input data 134 received from the client device(s) 120. For example, if the application 128 includes a gaming application, then the input data 134 may represent one or more inputs received by the client device(s) 120, where the input(s) is associated with controlling one or more aspects (e.g., one or more objects, one or more characters, etc.) of the gaming application. As such, the streaming component 130 and/or the CPU(s) 110 may process the input data 134 and then send, to the PPU(s) 108, data that causes the PPU(s) 108 to render the gaming application, which includes the video data.

The method 1200, at block B1204, may include generating audio data associated with the application. For instance, the streaming component 130 and/or the CPU(s) 110 may generate the audio data (e.g., a portion of the content data 136) associated with the application 128.

The method 1200, at block B1206, may include generating, using the one or more parallel processing units, processed video data by processing the video data using one or more first data processing techniques. For instance, the PPU(s) 108 may process the video data using the first data processing technique(s), such as the packet processing 138, the FEC processing 140, the protocol processing 142, the encryption processing 144, and/or any other type of data processing. Based at least on the processing, the PPU(s) 108 may generate the processed video data (e.g., a portion of the processed content data 156).

The method 1200, at block B1208, may include generating processed audio data by processing the audio data using one or more second data processing technique. For instance, in some examples, the CPU(s) 110 may process the audio data using the second data processing technique(s), such as the packet processing 150, the FEC processing 152, the encryption processing 154, and/or any other type of data processing. Additionally, or alternatively, in some examples, the PPU(s) 108 may process the audio data using the second data processing technique(s), such as the packet processing 138, the FEC processing 140, the protocol processing 142, the encryption processing 144, and/or any other type of data processing.

The method 1200, at block B1210, may include sending the processed video data and the processed audio data. For instance, the CPU(s) 110 may cause the communication interface(s) 160 to send the processed video data and the processed audio data to the client device(s) 120. In some examples, the CPU(s) 110 sends the processed video data and/or the processed audio data using the pace processing 158, such as packet pacing.

### Example Content Streaming System

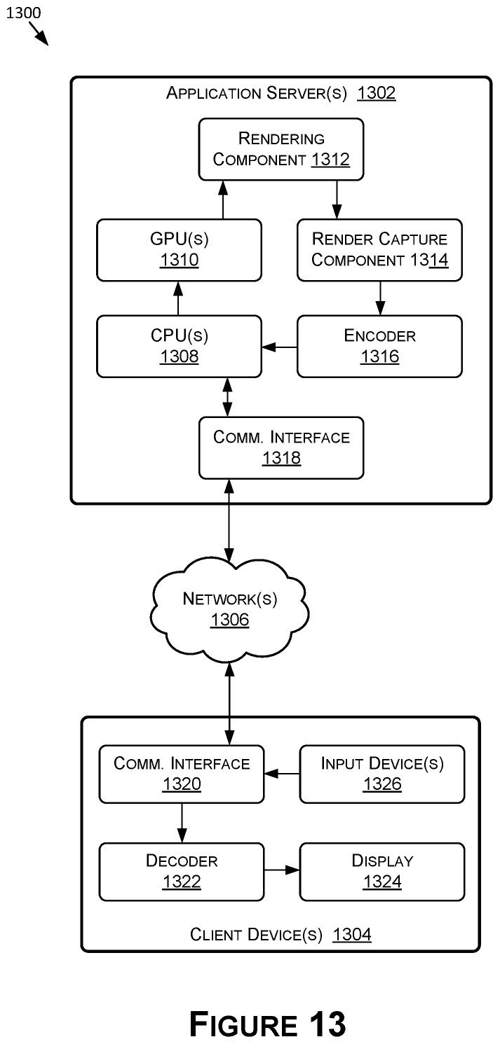

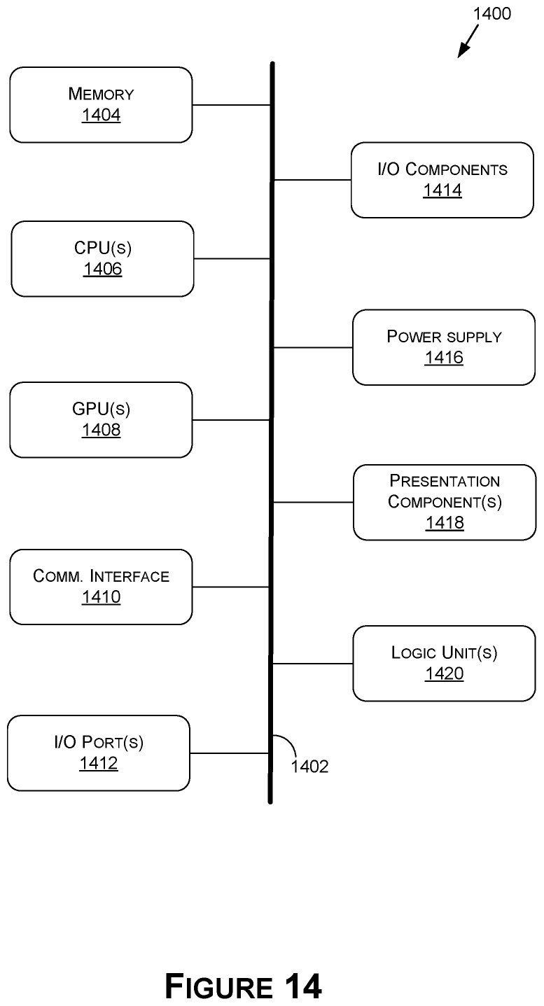

Now referring to FIG. 13, FIG. 13 is an example system diagram for a content streaming system 1300, in accordance with some embodiments of the present disclosure. FIG. 13 includes application server(s) 1302 (which may include similar components, features, and/or functionality to the example computing device 1400 of FIG. 14), client device(s) 1304 (which may include similar components, features, and/or functionality to the example computing device 1400 of FIG. 14), and network(s) 1306 (which may be similar to the network(s) described herein). In some embodiments of the present disclosure, the system 1300 may be implemented. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 1300, for an application session, the client device(s) 1304 may only receive input data in response to inputs to the input device(s), transmit the input data to the application server(s) 1302, receive encoded display data from the application server(s) 1302, and display the display data on the display 1324. As such, the more computationally intense computing and processing is offloaded to the application server(s) 1302 (e.g., rendering—in particular ray or path tracing—for graphical output of the application session is executed by the GPU(s) of the game server(s) 1302). In other words, the application session is streamed to the client device(s) 1304 from the application server(s) 1302, thereby reducing the requirements of the client device(s) 1304 for graphics processing and rendering.

For example, with respect to an instantiation of an application session, a client device 1304 may be displaying a frame of the application session on the display 1324 based on receiving the display data from the application server(s) 1302. The client device 1304 may receive an input to one of the input device(s) and generate input data in response. The client device 1304 may transmit the input data to the application server(s) 1302 via the communication interface 1320 and over the network(s) 1306 (e.g., the Internet), and the application server(s) 1302 may receive the input data via the communication interface 1318. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1312 may render the application session (e.g., representative of the result of the input data) and the render capture component 1314 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 1302. In some embodiments, one or more virtual machines (VMs)—e.g., including one or more virtual components, such as vGPUs, vCPUs, etc.—may be used by the application server(s) 1302 to support the application sessions. The encoder 1316 may then encode the display data to generate encoded display data and the encoded display data may be transmitted to the client device 1304 over the network(s) 1306 via the communication interface 1318. The client device 1304 may receive the encoded display data via the communication interface 1320 and the decoder 1322 may decode the encoded display data to generate the display data. The client device 1304 may then display the display data via the display 1324.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). In other words, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that enable the computing device 1400 to communicate with other computing devices via an electronic communication network, included wired and/or wireless communications. The communication interface 1410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may enable the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that enable detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to enable the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Data Center

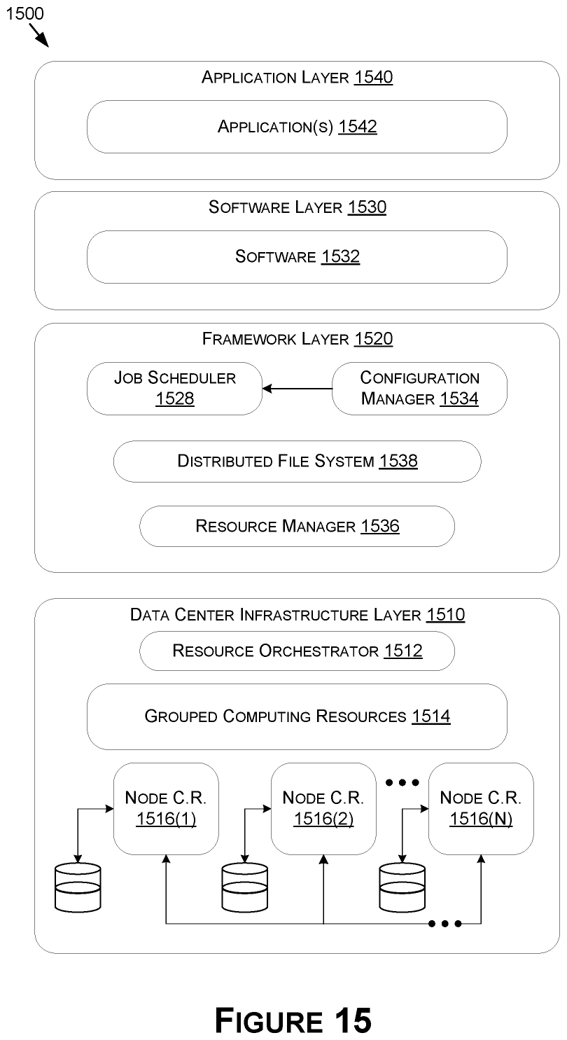

FIG. 15 illustrates an example data center 1500 that may be used in at least one embodiments of the present disclosure. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (“node C.R.s”) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1528, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter “Spark”) that may utilize distributed file system 1538 for large-scale data processing (e.g., “big data”). In at least one embodiment, job scheduler 1528 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1528. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, based at least on telemetry data associated with processing data for an application, one or more first data transport processes for one or more first processors to execute;
determining, based at least on the telemetry data, one or more second data transport processes for one or more second processors to execute;
executing the one or more first data transport processes using the one or more first processors and the one or more second data transport processes using the one or more second processors to generate content data associated with the application; and
sending the content data to one or more client devices.

2. The method of claim 1, wherein:
the telemetry data represents a profile associated with the application, the profile being associated with one or more processing statistics according to one or more processing metrics;
the determining the one or more first data transport processes for the one or more first processors to execute is based at least on the profile indicating that the one or more first processors are to execute the one or more first data transport processes; and
the determining the one or more second data transport processes for the one or more second processors to execute is based at least on the profile indicating that the one or more second processors are to execute the one or more second data transport processes.

3. The method of claim 2, wherein:
the one or more processing statistics are associated with one or more previous sessions associated with the application; and
the method further comprises generating, based at least on the one or more processing statistics, the profile to indicate that the one or more first processors are to execute the one or more first data transport processes and the one or more second processors are to execute the one or more second data transport processes.

4. The method of claim 1, wherein the determining the one or more second data transport processes for the one or more second processors to execute comprises:
determining, based at least on the data, that the one or more second data transport processes being executed by the one or more first processors causes one or more errors associated with streaming the content data; and
determining, based at least on the one or more errors associated with streaming the content data, to execute the one or more second data transport processes using the one or more second processors.

5. The method of claim 1, further comprising:
determining, based at least on second telemetry data associated with one or more second processing statistics associated with a second application, to execute the one or more second data transport processes using the one or more first processors;
generating, based at least on using the one or more first processors to execute the one or more second data transport processes for second content data, second processed content data associated with the second application; and
sending the second processed content data to one or more second client devices.

6. The method of claim 1, further comprising:
receiving, from the one or more client devices, a request to begin a session associated with the application,
wherein the determining the one or more first data transport processes for the one or more first processors to execute and the determining the one or more second data transport processes for the one or more second processors to execute is further based at least on the request.

7. The method of claim 1, wherein the one or more processing statistics comprise one or more of:
one or more first errors that occur based at least on the one or more first processors executing at least one of the one or more first data transport processes or the one or more second data transport processes;
one or more second errors that occur based at least on the one or more second processors executing at least one of the one or more first data transport processes or the one or more second data transport processes;
one or more bitrates associated with the application; or
one or more frame rates associated with the application.

8. The method of claim 1, further comprising:
receiving second data representative of one or more second processing statistics associated with one or more sessions associated with the application; and
causing an update of the data based at least on the one or more second processing statistics.

9. The method of claim 1, wherein:
the one or more first content processing tasks comprise one or more of:
a first packetization;
a first forward error correction;
a first encoding; or
a first encryption; and
the one or more second content processing tasks comprise one or more of:
a second packetization;
a second forward error correction;
a second encoding; or
a second encryption.

10. A system comprising:
one or more processing units to:
determine, based at least on telemetry data associated with an application, one or more first data transport processes associated with one or more central processing units and one or more second data transport processes associated with one or more parallel processing;
generate, based at least on using the one or more central processing units to process content data by executing the one or more first data transport processes and using the one or more parallel processing units to process the content data by executing the one or more second data transport processes, processed content data associated with the application; and
send the processed content data to one or more client devices.

11. The system of claim 10, wherein:
the data represents a profile associated with the application, the profile indicating the one or more first data transport processes associated with the one or more central processing units and the one or more second data transport processes associated with the one or more parallel processing units; and
the determination of the one or more first data transport processes associated with the one or more central processing units and the one or more second data transport processes associated with the one or more parallel processing units is based at least on the profile.

12. The system of claim 11, wherein:
the one or more processing statistics are associated with one or more previous sessions associated with the application; and
the one or more processing units are further to generate, based at least on the one or more processing statistics, the profile to indicate that the one or more first data transport processes are associated with the one or more central processing units and the one or more second data transport processes are associated with the one or more parallel processing units.

13. The system of claim 10, wherein the determination of the one or more second processes associated with the one or more parallel processing units comprises:
determining, based at least on the telemetry data, that the one or more second data transport processes being performed by the one or more central processing units causes one or more errors associated with streaming the content data; and
determining, based at least on the one or more errors associated with streaming the content data, to perform the one or more second data transport processes using the one or more parallel processing units.

14. The system of claim 10, wherein the one or more processing units are further to:
determine, based at least on second telemetry data associated with one or more second processing statistics associated with a second application, the one or more second data transport processes associated with the one or more central processing units;
generate, based at least on the one or more central processing units processing second content data using the one or more second data transport processes, second processed content data associated with the second application; and
send the second processed content data to one or more second client devices.

15. The system of claim 10, wherein the one or more processing units are further to:
receive, from the one or more client devices, a request to begin a session associated with the application,
wherein the determination of the one or more first data transport processes associated with the one or more central processing units and the one or more second data transport processes associated with the one or more parallel processing units is further based at least on the request.

16. The system of claim 10, wherein the one or more processing statistics comprise one or more of:
one or more first errors that occur based at least on the one or more central processing units performing at least one of the one or more first data transport processes or the one or more second data transport processes;
one or more second errors that occur based at least on the one or more parallel processing units performing at least one of the one or more first data transport processes or the one or more second data transport processes;
one or more bitrates associated with the application; or
one or more frame rates associated with the application.

17. The system of claim 10, wherein the one or more processing units to:
receive second telemetry data representative of one or more second processing statistics associated with one or more sessions associated with the application; and
cause an update of the telemetry data based at least on the one or more second processing statistics.

18. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

19. A processor comprising:
one or more graphics processing units to process content data associated with an application using one or more data transport processes to generate processed content data, wherein the one or more data transport processes are determined based at least on telemetry data associated with one or more processing statistics associated with the application; and
one or more central processing units to cause the processed content data to be streamed to the one or more client devices.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
